(19) United States
(12) Patent Application Publication
(10) Pub. No.: US 2013/0339569 A1
(43) Pub. Date: Dec. 19, 2013

(54) Storage System and Method for Operating Thereof

(71) Applicants: Yechiel YOCHAI, Moshav Aviel (IL); Michael DORFMAN, Ramat HaSharon (IL); Efri ZEIDNER, Haifa (IL)

(72) Inventors: Yechiel YOCHAI, Moshav Aviel (IL); Michael DORFMAN, Ramat HaSharon (IL); Efri ZEIDNER, Haifa (IL)

(73) Assignee: Infinidat Ltd., Herzliya (IL)

(21) Appl. No.: 13/517,644

(22) Filed: Jun. 14, 2012

(51) Int. Cl. G06F 12/02; G06F 12/08

(52) U.S. Cl. 711/102; 711/141; 711/135; 711/E12.007; 711/E12.022; 711/E12.026

(57) ABSTRACT

Storage system(s) for providing storing data in physical storage in a recurring manner, method(s) of operating thereof, and corresponding computer program product(s). For example, a possible method can include for each recurrence: generating a snapshot of at least one logical volume; destaging all data corresponding to the snapshot which was accommodated in the cache memory prior to a time of generating the snapshot and which was dirty at the time of generating said snapshot, thus giving rise to destaged data group; and after the destaged data group has been successfully destaged, registering an indication that the snapshot is associated with an order preservation consistency condition for the at least one logical volume, thus giving rise to a consistency snapshot.

### TECHNICAL FIELD

The presently disclosed subject matter relates to data storage systems and methods of operating thereof, and, in particular, to crash-tolerant storage systems and methods.

### BACKGROUND

In view of the business significance of stored data, organizations face a challenge to provide data protection and data recovery with the highest level of data integrity. Two primary techniques enabling data recovery are mirroring technology and snapshot technology.

In an extreme scenario of failure (also known as total crash), the ability to control the transfer of data between the control layer and the storage space, within the storage system, is lost. For instance, all server(s) in the storage system could have simultaneously failed due to a spark that hit the electricity system and caused severe damage to the server(s), or due to kernel panic. In this scenario, dirty data which was kept in cache, even if redundantly, will be lost and cannot be recovered. In addition, some metadata could have been lost because metadata corresponding to recent changes was not stored safety, and/or because a journal in which are registered metadata changes between two instances of metadata storing was not stored safely. Therefore, when the server(s) is/are repaired and the storage system is restored, it can be unclear whether or not the stored data can be used. By way of example, because of the lost metadata it can be unclear whether or not the data that is permanently stored in the storage space represents an order-preservation consistency condition important for crash consistency of databases and different applications.

The problems of crash-tolerant storage systems have been recognized in the contemporary art and various systems have been developed to provide a solution, for example:

U.S. Pat. No. 7,363,633 (Goldick et al) discloses an application programming interface protocol for making requests to registered applications regarding applications' dependency information so that a table of dependency information relating to a target object can be recursively generated. When all of the applications' dependencies are captured at the same time for given volume(s) or object(s), the entire volume's or object's program and data dependency information may be maintained for the given time. With this dependency information, the computer system advantageously knows not only which files and in which order to freeze or flush files in connection with a backup, such as a snapshot, or restore of given volume(s) or object(s), but also knows which volume(s) or object(s) can be excluded from the freezing process. After a request by a service for application dependency information, the computer system can translate or process dependency information, thereby ordering recovery events over a given set of volumes or objects.

U.S. Patent Application Publication Number 2010/0169592 (Atluri et al) discloses methods, software suites, and systems of generating a recovery snapshot and creating a virtual view of the recovery snapshot. In an embodiment, a method includes generating a recovery snapshot at a predetermined interval to retain an ability to position forward and backward when a delayed roll back algorithm is applied and creating a virtual view of the recovery snapshot using an algorithm tied to an original data, a change log data, and a consistency data related to an event. The method may include redirecting an access request to the original data based on a meta-data information provided in the virtual view. The method may further include substantially retaining a timestamp data, a location of a change, and a time offset of the change as compared with the original data.

U.S. Patent Application Publication Number 2005/0060607 (Kano) discloses restoration of data facilitated in the storage system by combining data snapshots made by the storage system itself with data recovered by application programs or operating system programs. This results in snapshots which can incorporate crash recovery features incorporated in application or operating system software in addition to the usual data image provided by the storage subsystem.

U.S. Patent Application Publication Number 2007/0220309 (Andre et al) discloses a continuous data protection system, and associated method, for point-in-time data recovery. The system includes a consistency group of data volumes. A support processor manages a journal of changes to the set of volumes and stores meta-data for the volumes. A storage processor processes write requests by: determining if the write request is for a data volume in the consistency group; notifying the support processor of the write request including providing data volume meta-data; and storing modifications to the data volume in a journal. The support processor receives a data restoration request including identification of the consistency group and a time for data restoration. The support processor uses the data volume meta-data to reconstruct a logical block map of the data volume at the requested time and directs the storage processor to make a copy of the data volume and map changed blocks from the journal into the copy.

U.S. Patent Application Publication Number 2006/0041602 (Lomet et al) discloses logical logging to extend recovery. In one aspect, a dependency cycle between at least two objects is detected. The dependency cycle indicates that the two objects should be flushed simultaneously from a volatile main memory to a non-volatile memory to preserve those objects in the event of a system crash. One of the two objects is written to a stable of to break the dependency cycle. The other of the two objects is flushed to the non-volatile memory. The object that has been written to the stable log is then flushed to the stable log to the non-volatile memory.

U.S. Patent Application Publication Number 2007/0061279 (Christiansen et al) discloses file system metadata regarding states of a file system affected by transactions tracked consistently even in the face of dirty shutdowns which might cause rollbacks in transactions which have already been reflected in the metadata. In order to only request time- and resource-heavy rebuilding of metadata for metadata which may have been affected by rollbacks, reliability information is tracked regarding metadata items. When a metadata item is affected by a transaction which may not complete properly in the case of a problematic shutdown or other event, that metadata item's reliability information indicates that it may not be reliable in case of such a problematic (“dirty” or “abnormal”) event. In addition to flag information indicating unreliability, timestamp information tracking a time of the command which has made a metadata item unreliable is also maintained. This timestamp information can then be used, along with information regarding a period after which the transaction will no longer cause a problem in the case of a problematic event, in order to reset the reliability information to indicate that the metadata item is now reliable even in the face of a problematic event.

### SUMMARY

In accordance with certain aspects of the presently disclosed subject matter, there is provided a method of operating a storage system which includes a cache memory operatively coupled to a physical storage space comprising a plurality of disk drives, the method comprising providing storing data in the physical storage in a recurring manner, wherein each recurrence comprises: generating a snapshot of at least one logical volume; destaging all data corresponding to the snapshot which was accommodated in the cache memory prior to a time of generating the snapshot and which was dirty at the time of generating the snapshot, thus giving rise to destaged data group; and after the destaged data group has been successfully destaged, registering an indication that the snapshot is associated with an order preservation consistency condition for the at least one logical volume, thus giving rise to a consistency snapshot.

In some of these aspects, if a total crash occurs, the method further comprises: restoring the storage system to a state of the system immediately before the crash and then returning the at least one logical volume to an order preservation consistency condition using last generated consistency snapshot.

Additionally or alternatively, in some of these aspects, time intervals between recurrences have equal duration.

Additionally or alternatively, in some of these aspects, a frequency of recurrences is dynamically adjustable.

Additionally or alternatively, in some of these aspects, the recurrence is initiated by the storage system upon occurrence of at least one event selected from a group comprising: power instability meets a predefined condition, cache overload meets a predefined condition, or kernel panic actions taken by an operational system.

Additionally or alternatively, in some of these aspects, the destaging includes: prioritizing destaging of the destaged data group from the cache memory.

Additionally or alternatively, in some of these aspects, the destaging includes: flushing from the cache memory the destaged data group as soon as possible after the generating of the snapshot.

Additionally or alternatively, in some of these aspects, the method further comprises: concurrently to generating the snapshot, inserting a checkpoint indicative of a separation point between the destaged data group and data accommodated in the cache memory after the generating, wherein the destaging includes: waiting until the checkpoint reaches a point indicative of successful destaging of the destaged data group from the cache memory.

Additionally or alternatively, in some of these aspects, the method further comprises: predefining one or more logical volumes as an order preservation consistency class, wherein the snapshot is generated for all logical volumes in the consistency class. Additionally or alternatively, in some examples of these aspects, all logical volumes in the storage system are predefined as an order preservation consistency class.

Additionally or alternatively, in some of these aspects the registering includes: registering the indication in a journal which includes details of storage transactions.

Additionally or alternatively, in some of these aspects, the method further comprises: storing the registered indication in non-volatile memory.

Additionally or alternatively, in some of these aspects, the method further comprises: scanning dirty data in the cache memory in order to select for destaging dirty data corresponding to the snapshot.

In accordance with further aspects of the of the presently disclosed subject matter, there is provided a storage system comprising: a physical storage space comprising a plurality of disk drives; and a cache memory, operatively coupled to the physical storage space; the storage system being operable to provide storing data in the physical storage in a recurring manner, including being operable, for each recurrence, to: generate a snapshot of at least one logical volume; destage all data corresponding to the snapshot which was accommodated in the cache memory prior to a time of generating the snapshot and which was dirty at the time of generating the snapshot, thus giving rise to destaged data group; and after the destaged data group has been successfully destaged, register an indication that the snapshot is associated with an order preservation consistency condition for the at least one logical volume, thus giving rise to a consistency snapshot.

In some of these aspects, the storage system is further operable, if a total crash occurs, to restore the storage system to a state of the system immediately before the crash and then to return the at least one logical volume to an order preservation consistency condition using last generated consistency snapshot.

Additionally or alternatively, in some of these aspects, operable to destage includes being operable to prioritize destaging of the destaged data group from the cache memory.

Additionally or alternatively, in some of these aspects, operable to destage includes being operable to flush from the cache memory the destaged data group as soon as possible after the snapshot is generated.

Additionally or alternatively, in some of these aspects, the storage system is further operable, concurrently to generating the snapshot, to insert a checkpoint indicative of a separation point between the destaged data group and data accommodated in the cache memory after the generating, wherein operable to destage includes being operable to wait until the checkpoint reaches a point indicative of successful destaging of the destaged data group from the cache memory.

Additionally or alternatively, in some of these aspects, the storage system is further operable to scan dirty data in the cache memory in order to select for destaging dirty data corresponding to the snapshot.

In accordance with further aspects of the of the presently disclosed subject matter, there is provided a computer program product comprising a non-transitory computer useable medium having computer readable program code embodied therein for operating a storage system which includes a cache memory operatively coupled to a physical storage space comprising a plurality of disk drives, the computer readable program code including computer readable program code for providing storing data in the physical storage space in a recurring manner, the computer program product comprising for each recurrence: computer readable program code for causing the computer to generate a snapshot of at least one logical volume; computer readable program code for causing the computer to destage all data corresponding to the snapshot which was accommodated in the cache memory prior to a time of generating the snapshot and which was dirty at the time of generating the snapshot, thus giving rise to destaged data group; and computer readable program code for causing the computer to, after the destaged data group has been successfully destaged, register an indication that the snapshot is associated with an order preservation consistency condition for the at least one logical volume, thus giving rise to a consistency snapshot.

### BRIEF DESCRIPTION OF THE DRAWINGS

In order to understand the subject matter and to see how it can be carried out in practice, examples will be described, with reference to the accompanying drawings, in which:

FIG. 1 illustrates an example of a functional block-diagram of a storage system, in accordance with certain embodiments of the presently disclosed subject matter;

FIG. 2 is a flow-chart of a method of operating a storage system in which storing data is provided in the physical storage, in accordance with certain embodiments of the presently disclosed subject matter; and

FIG. 3 illustrates a least recently used (LRU) list, in accordance with certain embodiments of the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter can be practiced without these specific details. In other non-limiting instances, well-known methods, procedures, components and circuits have not been described in detail so as not to obscure the presently disclosed subject matter.

As used herein, the phrases “for example,” “such as”, “for instance”, “e.g.” and variants thereof describe non-limiting embodiments of the subject matter.

Unless specifically stated otherwise, as apparent from the following discussions, it is appreciated that throughout the specification discussions utilizing terms such as “processing”, “computing”, “calculating”, “determining”, “generating”, “reading”, “writing”, “classifying”, “allocating”, “performing”, “storing”, “managing”, “configuring”, “caching”, “destaging”, “assigning”, “accommodating”, “registering” “associating”, “transmitting”, “enabling”, “restoring”, returning”, “prioritizing” “flushing”, “inserting”, “waiting”, “storing”, “scanning”, “selecting”, or the like, refer to the action and/or processes of a computer that manipulate and/or transform data into other data, said data represented as physical, such as electronic, quantities and/or said data representing the physical objects. The term “computer” should be expansively construed to cover any kind of electronic system with data processing capabilities, including, by way of non-limiting example, storage system and part(s) thereof disclosed in the present application.

The operations in accordance with the teachings herein can be performed by a computer specially constructed for the desired purposes or by a general purpose computer specially configured for the desired purpose by a computer program stored in a computer readable storage medium.

The references cited in the background teach many principles of recovery that are applicable to the presently disclosed subject matter. Therefore the full contents of these publications are incorporated by reference herein where appropriate for technical background, and/or for teachings of additional and/or alternative details.

Embodiments of the presently disclosed subject matter are not described with reference to any particular programming language. It will be appreciated that a variety of programming languages can be used to implement the teachings of the presently disclosed subject matter as described herein.

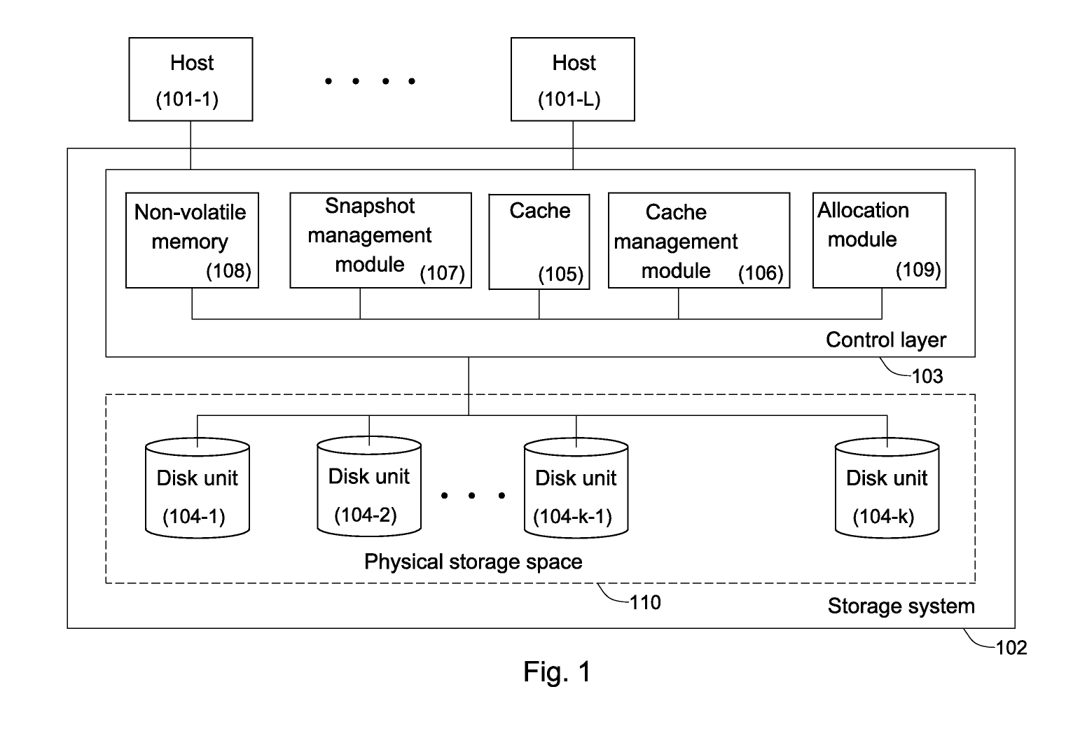

Bearing this in mind, attention is drawn to FIG. 1 illustrating an example of a functional block-diagram of a storage system, in accordance with certain embodiments of the presently disclosed subject matter.

One or more external host computers illustrated as 101-1-101-L share common storage means provided by a storage system 102. Storage system 102 comprises a storage control layer 103 (also referred to herein as “control layer”) and a physical storage space 110 (also referred to herein as “physical storage” or “storage space”). Storage control layer 103, comprising one or more servers, is operatively coupled to host(s) 101 and to physical storage space 110, wherein storage control layer 103 is configured to control interface operations (including I/O operations) between host(s) 101 and physical storage space 110. Optionally, the functions of control layer 103 can be fully or partly integrated with one or more host(s) 101 and/or physical storage space 110 and/or with one or more communication devices enabling communication between host(s) 101 and physical storage space 110.

Physical storage space 110 can be implemented using any appropriate permanent (non-volatile) storage medium and including, for example, one or more Solid State Disk (SSD) drives, Hard Disk Drives (HDD) and/or one or more disk units (DUs) (e.g. disk units 104-1-104-k), comprising several disk drives. Possibly, the DUs (if included) can comprise relatively large numbers of drives, in the order of 32 to 40 or more, of relatively large capacities, typically although not necessarily 1-2 TB. Possibly, physical storage space 110 can include disk drives not packed into disk units. Storage control layer 103 and physical storage space 110 can communicate with host(s) 101 and within storage system 102 in accordance with any appropriate storage protocol.

Storage control layer 103 can be configured to support any appropriate write-in-place and/or write-out-of-place technique, when receiving a write request. In a write-in-place technique a modified data block is written back to its original physical location in the storage space, overwriting the superseded data block. In a write-out-of-place technique a modified data block is written (e.g. in log form) to a different physical location than the original physical location in storage space 110 and therefore the superseded data block is not overwritten, but the reference to it is typically deleted, the physical location of the superseded data therefore becoming free for reuse. For the purpose of the discussion herein, data deletion is considered to be an example of data modification and a superseded data block refers to a data block which has been superseded due to data modification.

Similarly, when receiving a read request, storage control layer 103 is configured to identify the physical location of the desired data and further process the read request accordingly.

Optionally, storage control layer 103 can be configured to handle a virtual representation of physical storage space and to facilitate mapping between physical storage space 110 and its virtual representation. Stored data can possibly be logically represented to a client in terms of logical objects. Depending on storage protocol, the logical objects can be logical volumes, data files, image files, etc. A logical volume (also known as logical unit) is a virtual entity logically presented to a client as a single virtual storage device. The logical volume represents a plurality of data blocks characterized by successive Logical Block Addresses (LBA). Different logical volumes can comprise different numbers of data blocks, while the data blocks are typically although not necessarily of equal size (e.g. 512 bytes). Blocks with successive LBAs can be grouped into portions that act as basic units for data handling and organization within the system. Thus, for instance, whenever space is to be allocated in physical storage space 110 in order to store data, this allocation can be done in terms of data portions. Data portions are typically although not necessarily of equal size throughout the system. (For example, the size of a data portion can be 64 Kbytes). In embodiments with virtualization, the virtualization functions can be provided in hardware, software, firmware or any suitable combination thereof. In embodiments with virtualization, the format of logical representation provided by control layer 103 is not necessarily the same for all interfacing applications.

Storage control layer 103 illustrated in FIG. 1 comprises a volatile cache memory 105, a cache management module 106, a snapshot management module 107, an allocation module 109 and optionally a control layer non-volatile memory 108 (e.g. service disk drive). Any of cache memory 105, cache management module 106, snapshot management module 107, control layer non-volatile memory 108, and allocation module 109 can be implemented as centralized modules operatively connected to all of the server(s) comprised in storage control layer 103, or can be distributed over part of or all of the server(s) comprised in storage control layer 103.

Snapshot management module 107 is configured to generate snapshots of logical volume(s). The snapshots can be generated using any appropriate methodology, some of which are known in the art. Examples of known snapshot methodologies include “copy on write”, “redirect on write”, “split mirror”, etc. Common to snapshot methodologies is the feature that a snapshot can be used to return data, represented in the snapshot, which after the generation of the snapshot became superseded due to data modification. In accordance with certain embodiments of the presently disclosed subject matter, a generated snapshot can be associated with an order preservation consistency condition as will be described in more detail below. Optionally, snapshot management module 107 can also be configured to generate a snapshot which is unrelated to a consistency condition when requested to do so by any host 101.

Volatile cache memory 105 [e.g. (Random Access Memory) RAM memory in each server comprised in storage control layer 103] temporarily accommodates data to be written to physical storage space 110 in response to a write command and/or temporarily accommodates data to be read from physical storage space 110 in response to a read command.

During a write operation data to be written is temporarily retained in cache memory 105 until subsequently written to storage space 110. Such temporarily retained data is referred to hereinafter as “write-pending” data or “dirty data”. Once the write-pending data is sent (also known as “stored” or “destaged”) to storage space 110, its status is changed from “write-pending” to “non-write-pending”, and storage system 102 relates to this data as stored at storage space 110 and allowed to be erased from cache memory 105. Such data is referred to hereinafter as “clean data”. Optionally, clean data can be further temporarily retained in cache memory 105.

Storage system 102 acknowledges a write request when the respective data has been accommodated in cache memory 105. The write request is acknowledged prior to the write-pending data being stored in storage space 110. However, data in volatile cache memory 105 can be lost during a total crash in which the ability to control the transfer of data between cache memory 105 and storage space 110 within storage system 102 is lost. For instance, all server(s) comprised in storage control layer 103 could have simultaneously failed due, for example, to a spark that hit the electricity system and caused severe damage to the server(s), or due to kernel panic, and therefore such an ability could have been lost.

Cache management module 106 is configured to regulate activity in cache memory 105, including destaging dirty data from cache memory 105.

Allocation module 109 is configured to register an indication that a snapshot generated of at least one logical volume is associated with an order preservation consistency condition for that/those logical volume(s). For example, there can be a data volume table or other data structure tracking details (e.g. size, name, etc) relating to all logical volumes in the system, including corresponding snapshots. Allocation module 109 can be configured to update the data structure to register this indication once a generated snapshot, listed in the data structure, can be associated with an order preservation consistency condition. Additionally or alternatively, for example, allocation module 109 can be configured to register this indication in a journal or other data structure which registers storage transaction details. Optionally, allocation module 109 can be configured to store the registered indication in non-volatile memory (e.g. in control layer 103 or in physical space 110)

Optionally, allocation module 109 can be configured to predefine one or more logical volumes as an order preservation consistency class, so that a snapshot can be generated for all logical volumes in the class, as will be explained in more detail below.

Optionally, allocation module 109 can be configured to perform other conventional tasks such as allocation of physical location for destaging data, metadata updating, registration of storage transactions, etc.

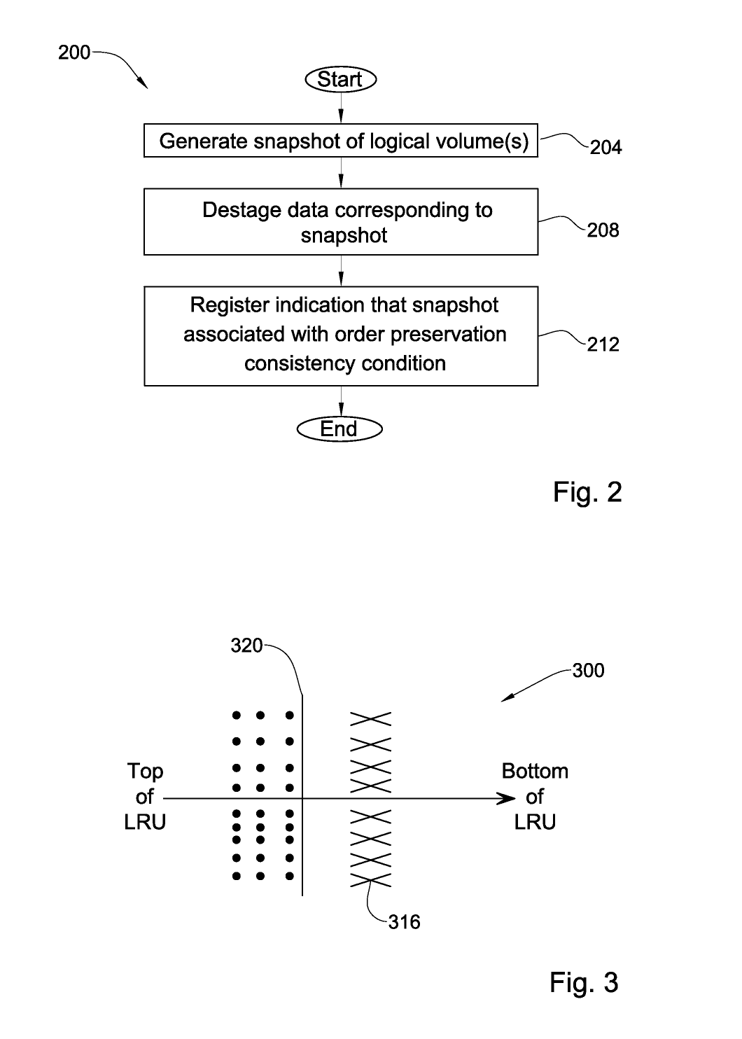

Storage system 102 can operate as illustrated in FIG. 2 which is a flow-chart of a method 200 in which storing data is provided in physical storage 110, in accordance with certain embodiments of the presently disclosed subject matter.

In a conventional manner of destaging, the data in cache memory 105 is not necessarily destaged in the same order that the data was accommodated in cache memory 105 because the destaging can take into account other consideration(s) in addition to or instead of the order in which the data was accommodated. Data destaging can be conventionally performed by way of any replacement technique. For example, a possible replacement technique can be a usage-based replacing technique. A usage-based replacing technique conventionally includes an access based movement mechanism in order to take into account certain usage-related criteria when destaging data from cache memory 105. Examples of usage-based replacing techniques include, known in the art LRU (Least Recently Used) technique, LFU (Least Frequently Used) technique, MFU (Most Frequently Used) technique, weighted-LRU techniques, pseudo-LRU techniques, etc.

An order preservation consistency condition is a type of consistency condition where if a first write command for writing a first data value is received before a second write command for writing a second data value, and the first command was acknowledged, then if the second data value is stored in storage space 110, the first data value is necessarily also stored in storage space 110. As conventional destaging does not necessarily destage data in the same order that the data was accommodated, conventional destaging does not necessarily result in an order preservation consistency condition. It is therefore possible that under conventional destaging, even if the second data value is already stored in storage space 110, the first data value can still be in cache memory 105 and would be lost upon a total crash where the ability to control the transfer of data between cache memory 105 and storage space 110 within storage system 102 is lost.

Embodiments of method 200 which will now be described enable data in storage space 110 to be returned to an order preservation consistency condition, if a total crash occurs. Herein the term consistency or the like refers to order-preservation consistency. The disclosure does not limit the situations where it can be desirable to be able to return data to an order preservation consistency condition but for the purpose of illustration only, some examples are now presented. For example, when updating a file system, it can be desirable that there be a consistency condition between metadata modification of a file system and data modification of a file system so that if the metadata modification of the file system is stored in storage space 110, the data modification of the file is necessarily also stored in storage space 110. Additionally or alternatively for example, it can be desirable that there be a consistency condition relating to a journal for possible recovery of a database and data in a database so that if the journal for possible recovery of a database is stored in the storage space 110, the data in the database is necessarily also stored in the storage space 110.

In accordance with method 200, storing data is provided in physical storage 110 in a recurring manner FIG. 2 illustrates stages included in each recurrence. Because the frequency of these recurrences, and/or time intervals between these recurrences are not limited by the currently disclosed subject matter, FIG. 2 does not illustrate a plurality of recurrences nor any relationship between them.

Optionally, prior to generating a snapshot of logical volume(s), the logical volume(s) can be predefined as an order preservation consistency class so that the snapshot is generated for all logical volumes in the consistency class. Under this option, the disclosure does not limit the number of logical volume(s) predefined as an order preservation consistency class and possibly all logical volumes in storage system 102 can be predefined as an order preservation consistency class or less than all of the logical volumes in storage system 102 can be predefined as an order preservation consistency class.

Refer now to the illustrated stages of FIG. 2, corresponding to a recurrence.

In the illustrated example, storage system 102, for instance snapshot management module 107, generates (204) a snapshot of one or more logical volumes.

The disclosure does not limit which snapshot methodology to use, and therefore the snapshot can be generated using any appropriate snapshot methodology, some of which are known in the art.

The disclosure also does not limit the number of logical volumes(s), nor limits which logical volume(s) of which a snapshot is generated. Possibly, a snapshot can be generated of all of the logical volumes in storage system 102, thereby enabling the returning of all data (also termed herein “the entire dataset”) in storage space 110 to an order preservation consistency condition, if a total crash occurs. However, it is also possible that the snapshot is generated of less than all of the logical volumes in storage system 102, thereby enabling the returning of only some, but not all, of the data in storage space 110 to an order preservation consistency condition, if a total crash occurs. The decision on whether a snapshot should be generated of a particular logical volume, consequently enabling that logical volume to be returned to an order preservation consistency condition if a total crash occurs, can be at least partly based, for instance, on whether or not the requests received from hosts 101 relating to that particular logical volume imply that it would be desirable to be able to return that logical volume to an order preservation consistency condition, if a total crash occurs. Additionally or alternatively, the decision can be at least partly based on a specification received from outside storage system 102 that a snapshot should be generated of particular logical volume(s).

Storage system 102, for instance cache management module 106, destages (208) from cache memory all data, corresponding to the generated snapshot, which was accommodated in cache memory 105 prior to the time of generating the snapshot and which was dirty at the time of generating the snapshot. This data is also termed herein “destaged data group”.

Storage system 102 can apply any suitable write in place and/or write out of place technique when destaging the destaged data group. Optionally other data besides the destaged data group can also be destaged concurrently.

The disclosure does not limit the technique used by storage system 102 (e.g. cache management module 106) to destage the destaged data group. However for the purpose of illustration only, some examples are now presented.

For example, storage system 102 can flush the destaged data group, as soon as possible after generating the snapshot. Optionally, other data can be flushed while flushing the destaged data group, for instance other data which is not associated with the snapshot, but which was accommodated in cache memory 105 prior to the time of generating the snapshot and which was dirty at the time of generating the snapshot. An alternative option is that only the destaged data group is flushed, for instance with the destaged data group selected through scanning as described below. Possibly, after the snapshot has been generated, no other destaging takes place until the flushing is completed, but this is not necessarily required.

In another example, storage system 102 can prioritize the destaging of the destaged data group, for instance with the destaged data group selected through scanning as described in more detail below. Prioritizing can include any activity which interferes with the conventional destaging process, so as to cause the destaging of the destaged data group to be completed earlier than would have occurred had there been no prioritization.

In another example, storage system 102 can wait until the destaged data group is destaged without necessarily prioritizing the destaging.

Optionally, storage system 102 can execute one or more additional operations prior to or during the destaging, in order to assist the destaging process. Although the disclosure does not limit these operations, for the purpose of illustration only some examples are now presented.

For example, in order to assist the destaging, concurrently to generating the snapshot, storage system 102 can optionally insert a checkpoint indicative of a separation point between the destaged data group and data accommodated in cache memory 105 after the generation of the snapshot. Optionally the checkpoint can also be indicative of a separation point between other data accommodated in cache memory 105 prior to the generation of the snapshot and data accommodated in cache memory 105 after the generation of the snapshot. For example the other data can include data which was not dirty at the time of generation of the snapshot and/or other dirty data which does not correspond to the snapshot. This other data is termed below for convenience as “other previously accommodated data”.

The checkpoint can be, for example, a recognizable kind of element identifiable by a certain flag in its header. Storage system 102 (e.g. cache management module 106) can be configured to check the header of an element, and, responsive to recognizing a checkpoint, to handle the checkpoint in an appropriate manner. For instance, a possible appropriate manner of handing a checkpoint can include storage system 102 ceasing waiting for the destaging of the destaged data group to be completed and proceeding to stage 216 once the checkpoint reaches a point indicative of successful destaging of the destaged data group from cache memory 105.

For purpose of illustration only, assume that the caching data structure in this example is an LRU linked list. Depending on the instance, the LRU list can be an LRU list with elements representing dirty data in cache memory 105 or an LRU with elements representing dirty data and elements representing not dirty data in cache memory 105. Those skilled in the art will readily appreciate that the caching data structure can alternatively include any other appropriate data structure associated with any appropriate replacement technique.

FIG. 3 illustrates an LRU data linked list 300, in accordance with certain embodiments of the presently disclosed subject matter. An LRU linked list (such as list 300) can include a plurality of elements with one of the elements indicated by an external pointer as representing the least recently used data. Concurrently to generating the snapshot, storage system 102 can insert a checkpoint (e.g. 320) at the top of the LRU list. In an LRU technique, dirty data which is to be destaged earlier is considered represented by an element closer to the bottom of the list than dirty data which is to be destaged later. Therefore since checkpoint 320 indicates a separation point between the destaged data group, and data accommodated in cache memory 105 after the generation of the snapshot, the destaged data group (and optionally other previously accommodated data) can be considered as represented by elements 316 which are below checkpoint 320 in LRU list 300.

Storage system 102 (e.g. cache management module 106) can recognize, with reference to FIG. 3, when the bottom element of list 300 is checkpoint 320 (e.g. by checking the header). When checkpoint 320 reaches the bottom of list 300, it is a point indicative of successful destaging of the destaged data group. Storage system 102 (e.g. allocation module 109) can then cease waiting and proceed to stage 212. As mentioned above, data other than the destaged data group can optionally be destaged concurrently to the destaged data group, and consequently can be destaged between the time that checkpoint 320 is inserted in LRU list 300 and the time checkpoint 320 reaches the bottom of list 300.

Additionally or alternatively, for example, in order to assist the destaging, storage system 102, (e.g. cache management module 106) can optionally scan dirty data in cache memory 105 in order to select for destaging dirty data corresponding to the snapshot. Assuming scanning takes place, besides the dirty data, non-dirty data in cache memory 105 can optionally also be scanned when selecting for destaging the dirty data corresponding to the snapshot. The selected data collectively is the destaged data group. The scanning can take place, for instance, as soon as possible after generation of the snapshot.

For purpose of illustration only, assume that the caching data structure in this example is an LRU linked list. Depending on the instance, the LRU list can be an LRU list with elements representing dirty data in cache memory 105 or an LRU with elements representing dirty data and elements representing not dirty data in cache memory 105. Those skilled in the art will readily appreciate that the caching data structure can alternatively include any other appropriate data structure associated with any appropriate replacement technique.

In one instance of this scanning example, an LRU list represents dirty data. In this instance, storage system 102 (e.g. cache management module 106) can scan the LRU list, in order to select for destaging data which relates to logical block addresses in logical volume(s) of the generated snapshot. In another instance, where the LRU list represents both dirty and non-dirty data, storage system 102 can scan the LRU list, in order to select for destaging only dirty data which relates to logical block addresses in logical volume(s) of the generated snapshot. Alternatively or additionally, for instance, storage system 102 (e.g. cache management module 106) can be configured to tag data (e.g. with a special flag in the header of the representative element) as relating to a logical volume in an order preservation consistency class upon accommodation in cache 105. In this instance, if the LRU list also represents non-dirty data, storage system 102 can be configured to remove the tag if and when the data is no longer dirty. In this instance, storage system 102 can scan the LRU list and determine that data should be selected for destaging if the data is tagged as described.

The disclosure does not limit which destaging technique is used for the data selected by scanning (which collectively is the destaged data group) in instances where scanning takes place. However, for the purpose of illustration only, some instances are now presented. For instance, the selected data can be flushed. Alternatively, for instance, the selected data can have destaging thereof prioritized. Storage system 102 (e.g. cache management module 106) can track the selected data and thus determine when all of the destaged data group has been destaged, The tracking of the selected data can be performed using any appropriate techniques, some of which are known in the art.

In the illustrated example, storage system 102 (e.g. allocation module 109) registers (212) an indication that the snapshot generated in stage 204 of at least one logical volume is associated with an order preservation consistency condition for that/those logical volume(s). The snapshot can therefore now be considered a consistency snapshot for that/those logical volume(s).

The disclosure does not limit how storage system 102 so indicates but for the purpose of illustration only, some examples are now provided. For example, there can be a data volume table or other data structure tracking details (e.g. size, name, etc) relating to all logical volumes in the system, including corresponding snapshots. Once a generated snapshot, listed in the data structure, is associated with an order preservation consistency condition, an indication can be registered in the data structure. Additionally or alternatively, for example, the indication can be registered in a journal or other data structure which registers storage transaction details.

Optionally, storage system 102 (e.g. allocation module 109) can store the registered indication in non-volatile memory.

After the indication has been registered (and optionally the registered indication stored), storage system 102 (e.g. snapshot management module 107) can optionally delete a snapshot which was generated in a previous recurrence.

Depending on the example, the time intervals between recurrences can have equal duration (e.g. occurring every 5 to 10 minutes) or not necessarily equal duration. In examples, with not necessarily equal duration, the frequency of recurrences can be dynamically adjustable or can be set.

Optionally, a recurrence can be initiated by storage system 102 upon occurrence of one or more events such as power instability meeting a predefined condition, cache overload meeting a predefined condition, operational system taking kernel panic actions, etc.

Depending on the example, the destaging of data associated with the same logical volume(s) (of which snapshots are generated during the recurrences) can be allowed or not allowed between recurrences.

Optionally if there is any data corresponding to different logical volume(s) (i.e. not to logical volume(s) of which snapshots are generated during the recurrences) this data can be handled in any suitable way, some of which are known in the art. For example, this data can be destaged independently of the recurrences, during recurrences, and/or in between recurrences, etc.

Storage system 102 can be returned to an order preservation consistency condition if a total crash occurs.

Assuming a total crash has occurred, then once the server(s) have been repaired, storage system 102 (e.g. allocation module 109) can restore the storage system to the state of the system immediately before the crash in any suitable way, some of which are known in the art. Storage system 102 (e.g. allocation module 109) can then return snapshot-corresponding logical volume(s) to an order preservation consistency condition using the last generated consistency snapshot corresponding to the logical volume(s) (i.e. using the last generated snapshot for which has been registered an indication that the snapshot is associated with an order preservation consistency condition for the logical volume(s)).

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the presently disclosed subject matter.

It is also to be understood that any of the methods described herein can include fewer, more and/or different stages than illustrated in the drawings, the stages can be executed in a different order than illustrated, stages that are illustrated as being executed sequentially can be executed in parallel, and/or stages that are illustrated as being executed in parallel can be executed sequentially. Any of the methods described herein can be implemented instead of and/or in combination with any other suitable storage techniques.

It is also to be understood that certain embodiments of the presently disclosed subject matter are applicable to the architecture of storage system(s) described herein with reference to the figures. However, the presently disclosed subject matter is not bound by the specific architecture; equivalent and/or modified functionality can be consolidated or divided in another manner and can be implemented in any appropriate combination of software, firmware and/or hardware. Those versed in the art will readily appreciate that the presently disclosed subject matter is, likewise, applicable to any storage architecture implementing a storage system. In different embodiments of the presently disclosed subject matter the functional blocks and/or parts thereof can be placed in a single or in multiple geographical locations (including duplication for high-availability); operative connections between the blocks and/or within the blocks can be implemented directly (e.g. via a bus) or indirectly, including remote connection. The remote connection can be provided via Wire-line, Wireless, cable, Internet, Intranet, power, satellite or other networks and/or using any appropriate communication standard, system and/or protocol and variants or evolution thereof (as, by way of non-limiting example, Ethernet, iSCSI, Fiber Channel, etc.).

It is also to be understood that for simplicity of description, some of the embodiments described herein ascribe a specific method stage and/or task to a particular module within the storage control layer. However in other embodiments the specific stage and/or task can be ascribed more generally to the storage system or storage control layer and/or more specifically to any module(s) in the storage system.

It is also to be understood that the system according to the presently disclosed subject matter can be, at least partly, a suitably programmed computer. Likewise, the presently disclosed subject matter contemplates a computer program being readable by a computer for executing the method of the presently disclosed subject matter. The subject matter further contemplates a machine-readable memory tangibly embodying a program of instructions executable by the machine for executing a method of the subject matter.

Those skilled in the art will readily appreciate that various modifications and changes can be applied to the embodiments of the presently disclosed subject matter as hereinbefore described without departing from its scope, defined in and by the appended claims.

1. A method of operating a storage system which includes a cache memory operatively coupled to a physical storage space comprising a plurality of disk drives, the method comprising providing storing data in the physical storage in a recurring manner, wherein each recurrence comprises:
generating a snapshot of at least one logical volume;
destaging all data corresponding to said snapshot which was accommodated in said cache memory prior to a time of generating said snapshot and which was dirty at said time of generating said snapshot, thus giving rise to destaged data group; and
after said destaged data group has been successfully destaged, registering an indication that said snapshot is associated with an order preservation consistency condition for said at least one logical volume, thus giving rise to a consistency snapshot.

2. The method of claim 1, wherein if a total crash occurs, the method further comprises: restoring the storage system to a state of the system immediately before the crash and then returning said at least one logical volume to an order preservation consistency condition using last generated consistency snapshot.

3. The method of claim 1, wherein time intervals between recurrences have equal duration.

4. The method of claim 1, wherein a frequency of recurrences is dynamically adjustable.

5. The method of claim 1, wherein said recurrence is initiated by the storage system upon occurrence of at least one event selected from a group comprising: power instability meets a predefined condition, cache overload meets a predefined condition, or kernel panic actions taken by an operational system.

6. The method of claim 1, wherein said destaging includes: prioritizing destaging of said destaged data group from said cache memory.

7. The method of claim 1, wherein said destaging includes: flushing from said cache memory said destaged data group as soon as possible after said generating of said snapshot.

8. The method of claim 1, further comprising: concurrently to generating said snapshot, inserting a checkpoint indicative of a separation point between said destaged data group and data accommodated in said cache memory after said generating, wherein said destaging includes: waiting until said checkpoint reaches a point indicative of successful destaging of said destaged data group from said cache memory.

9. The method of claim 1, further comprising: predefining one or more logical volumes as an order preservation consistency class, wherein the snapshot is generated for all logical volumes in the consistency class.

10. The method of claim 9, wherein all logical volumes in the storage system are predefined as an order preservation consistency class.

11. The method of claim 1, wherein said registering includes: registering said indication in a journal which includes details of storage transactions.

12. The method of claim 1, further comprising: storing said registered indication in non-volatile memory.

13. The method of claim 1, further comprising: scanning dirty data in said cache memory in order to select for destaging dirty data corresponding to said snapshot.

14. A storage system comprising:
a physical storage space comprising a plurality of disk drives; and
a cache memory, operatively coupled to said physical storage space;
said storage system being operable to provide storing data in the physical storage in a recurring manner, including being operable, for each recurrence, to:
generate a snapshot of at least one logical volume;
destage all data corresponding to said snapshot which was accommodated in said cache memory prior to a time of generating said snapshot and which was dirty at said time of generating said snapshot, thus giving rise to destaged data group; and
after said destaged data group has been successfully destaged, register an indication that said snapshot is associated with an order preservation consistency condition for said at least one logical volume, thus giving rise to a consistency snapshot.

15. The storage system of claim 14, further operable, if a total crash occurs, to restore the storage system to a state of the system immediately before the crash and then to return the at least one logical volume to an order preservation consistency condition using last generated consistency snapshot.

16. The storage system of claim 14, wherein said operable to destage includes being operable to prioritize destaging of said destaged data group from said cache memory.

17. The storage system of claim 14, wherein said operable to destage includes being operable to flush from said cache memory said destaged data group as soon as possible after said snapshot is generated.

18. The storage system of claim 14, further operable, concurrently to generating said snapshot, to insert a checkpoint indicative of a separation point between said destaged data group and data accommodated in said cache memory after said generating, wherein said operable to destage includes being operable to wait until said checkpoint reaches a point indicative of successful destaging of said destaged data group from said cache memory.

19. The storage system of claim 14, further operable to scan dirty data in said cache memory in order to select for destaging dirty data corresponding to said snapshot.

20. A computer program product comprising a non-transitory computer useable medium having computer readable program code embodied therein for operating a storage system which includes a cache memory operatively coupled to a physical storage space comprising a plurality of disk drives, said computer readable program code including computer readable program code for providing storing data in the physical storage space in a recurring manner, the computer program product comprising for each recurrence:
computer readable program code for causing the computer to generate a snapshot of at least one logical volume;
computer readable program code for causing the computer to destage all data corresponding to said snapshot which was accommodated in said cache memory prior to a time of generating said snapshot and which was dirty at said time of generating said snapshot, thus giving rise to destaged data group; and
computer readable program code for causing the computer to, after said destaged data group has been successfully destaged, register an indication that said snapshot is associated with an order preservation consistency condition for said at least one logical volume, thus giving rise to a consistency snapshot.
